(19) United States
(12) Patent Application Publication
(10) Pub. No.: US 2010/0197345 A1
(43) Pub. Date: Aug. 5, 2010

(54) Remote video recorder for a mobile phone

(76) Inventor: Ahmed Ali Ahmed Bawareth, Dhahran (SA)

Correspondence Address: LITMAN LAW OFFICES, LTD., POST OFFICE BOX 41200, SOUTH STATION, ARLINGTON, VA, 22204, US

(21) Appl. No.: 12/320,735

(22) Filed: Feb. 3, 2009

(51) Int. Cl. H04M 1/00

(52) U.S. Cl. 455/557

(57) ABSTRACT

The remote video recorder for a mobile phone is an installation that includes a third generation (3G) mobile phone having a call filtering program, a video call answering program either built into the phone or in a device connected to the phone, and a memory storage device connected to the phone. When a user takes a photograph or streaming video on a mobile phone that he wishes to store on the remote video recorder, he presses a shortcut button that calls the 3G phone connected to the remote video recorder. The call filtering program limits access only to the user(s) phone. The video call answering program detects that the incoming call is for the transmission of a still photograph or video, and routes the incoming transmission to the memory device, which may be a computer, for storage.

### BACKGROUND OF THE INVENTION

1. Field of the Invention

The present invention relates to mobile or cellular telephone systems, and particularly to a remote video recorder for a mobile phone.

2. Description of the Related Art

A camera phone is a mobile phone having a built in camera. Such a phone is generally interoperable with a server-based infrastructure or protocol, such as, e.g., Multimedia Messaging Service (MMS), that allows the user to instantly share pictures and video with someone that has a compatible receiving device.

Presently, it is commonplace to have a megapixel camera phone with video and/or still picture capability. These “camera phones” are playing significant roles in an individual's ability to participate in crime prevention, ad hoc journalism, and the like.

City officials are encouraging people to use their camera phones to capture crimes happening in progress, explosions, fires, or dangerous situations and send them to appropriate emergency personnel, news organizations, and the like. With peer-to-peer video call features being the norm, home-grown videographic and photographic “street” journalism is growing exponentially. The ability to immediately record and share multimedia content anywhere makes potentially every person with a cell or mobile phone a roving news reporter.

The technology and infrastructure behind this capability is generally referred to as third generation (3G) wireless, and may include a Universal Mobile Telecommunications System (UMTS) or the like as an underlying cell phone technology that can support peer-to-peer live video transmission from mobile cell phones. Mobile phones supporting UMTS networks can work as videophones using their internal camera, and can make video calls wirelessly to other UMTS users worldwide.

With the ever increasing demand for video phone services, there exists a long felt need for archiving and recording facilities that can accept and record live shot video streaming for later use in newsrooms, digital photo albums, personal use, and the like.

In addition, cell or mobile phones have the capability to store still photographs or streaming video taken by the integral camera onto a memory chip. However, storage capacity is limited by the size of the memory chip. In addition, when the phone is a business phone or a phone borrowed for short-term use, the user may not wish to store the photograph or video on the on-board memory chip, but for reasons of privacy, may wish to store the photograph or video directly at a remote location that has limited access and potentially greater memory storage capability.

Thus, a remote video recorder for a mobile phone solving the aforementioned problems is desired.

### SUMMARY OF THE INVENTION

The remote video recorder for a mobile phone is an installation that includes a third generation (3G) mobile phone having a call filtering program, a video call answering program either built into the phone or in a device connected to the phone, and a memory storage device connected to the phone. When a user takes a photograph or streaming video on a mobile phone that he wishes to store on the remote video recorder, he presses a shortcut button, either actual or touch screen, that calls the 3G phone connected to the remote video recorder, instead of saving the video to an on-board chip. The call filtering program limits access to only the user(s) phone. The video call answering program detects that the incoming call is for the transmission of a still photograph or video, and routes the incoming transmission to the memory device, which may be a computer, for storage.

These and other features of the present invention will become readily apparent upon further review of the following specification and drawings.

### BRIEF DESCRIPTION OF THE DRAWINGS

FIG. 1 is an environmental, block diagram of the remote video recorder for a mobile phone according to the present invention.

FIG. 2 is a block diagram of subsystems of the remote video recorder for a mobile phone according to the present invention.

FIG. 3 is a flowchart of the steps in using a remote video recorder for a mobile phone according to the present invention.

Similar reference characters denote corresponding features consistently throughout the attached drawings.

### DETAILED DESCRIPTION OF THE PREFERRED EMBODIMENT

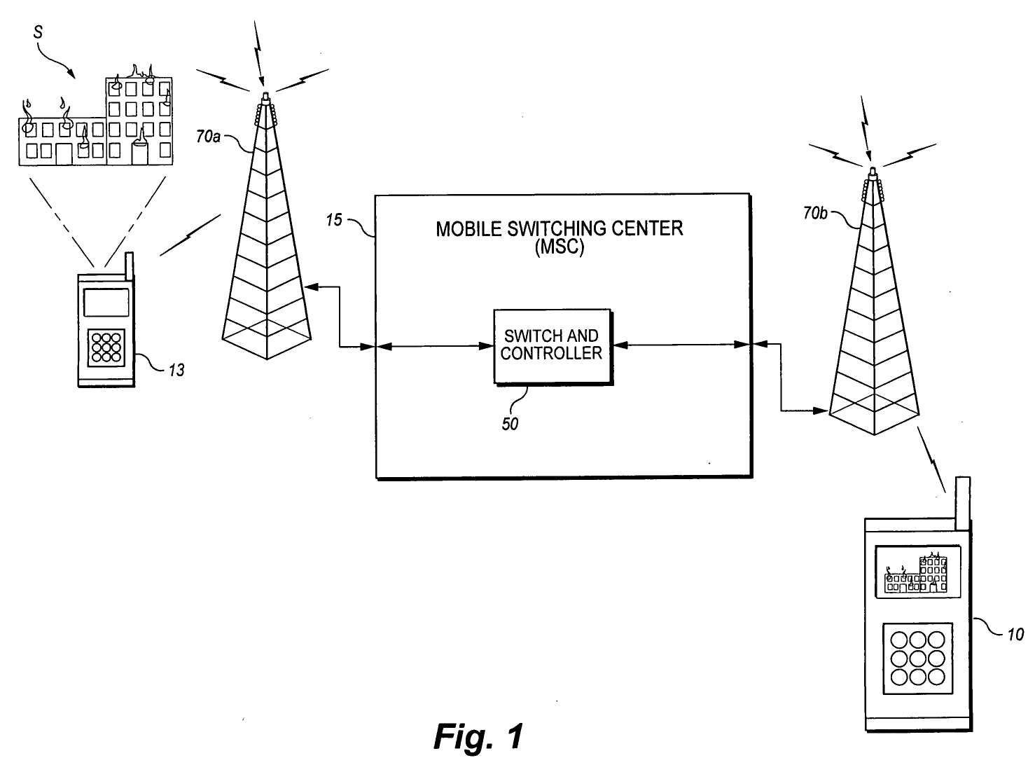

As shown in FIGS. 1-3, the present invention is a remote video recorder for a mobile phone. The remote video recorder is a third generation (3G) mobile phone 10 having a processor 200 connected to an RF transceiver 205, a display 215, and a keypad 230. The 3G phone 10 has a call filtering program 210 operably connected to the microprocessor 200, either programmed or built into the 3G phone or as a standalone device connected to the 3G phone. The call filtering program 210 checks a number and only accepts calls from one or more telephone numbers specified by the user. Call filtering devices and software are well known and will not be described further.

The telephone number assigned to the 3G phone 10 may be a private and/or unpublished number that is not generally known. Moreover, to facilitate fast and easy one-touch dialing to the device 10, a caller using a camera phone 13 should replace his/her single digit voice mailbox number shortcut with the telephone number of 3G phone 10.

A video recording memory 220 or memory storage device is adapted for recording video data and associated audio data and is activated by an automatic video call answering program 225 that detects when a video image or video data stream is available from the incoming call and routes the video data to the video recording memory 220 for storage thereon. Video recording memory 220 may be digital memory, such as internal FLASH, RAM, DRAM, a memory card insertable into the third generation mobile phone 10, or the like. Alternatively, the video recording memory 220 may be provided by a computer having a hard disk drive for memory storage, the computer communicating with the 3G phone 10 in any conventional manner. Any video data sent by the callers can be recorded into the video recording memory 220.

As shown in FIG. 1, the infrastructure enabling the remote video recorder comprises a plurality of cell towers, such as cell tower 70a, within range of camera/videophone 13 and cell tower 70b in range of the 3G phone 10. Call data is setup and relayed via mobile switching center (MSC) 15. Mobile switching center 15 comprises a switch and controller 50 to facilitate communication between the caller's phone 13 and the 3G phone 10. Cell phones 13 and 10, along with MSC 15, provide at least 3G (third generation) mobile phone feature capability, such as a Universal Mobile Telecommunications System (UMTS) utilizing W-CDMA (Wideband Code Division Multiple Access) or Evolution-Data Optimized system (EV-DO), and the like.

As shown in FIG. 1, a caller wishing to memorialize a scene, such as burning building S, may, via cell tower 70a, MSC 15, and cell tower 70b, place a call to 3G phone 10. If the phone number belonging to device 13 is not filtered out by call filtering program 210 of device 10, then the call setup is allowed to complete, thereby allowing video of the burning building scene S to be transmitted to device 10 for display and recording.

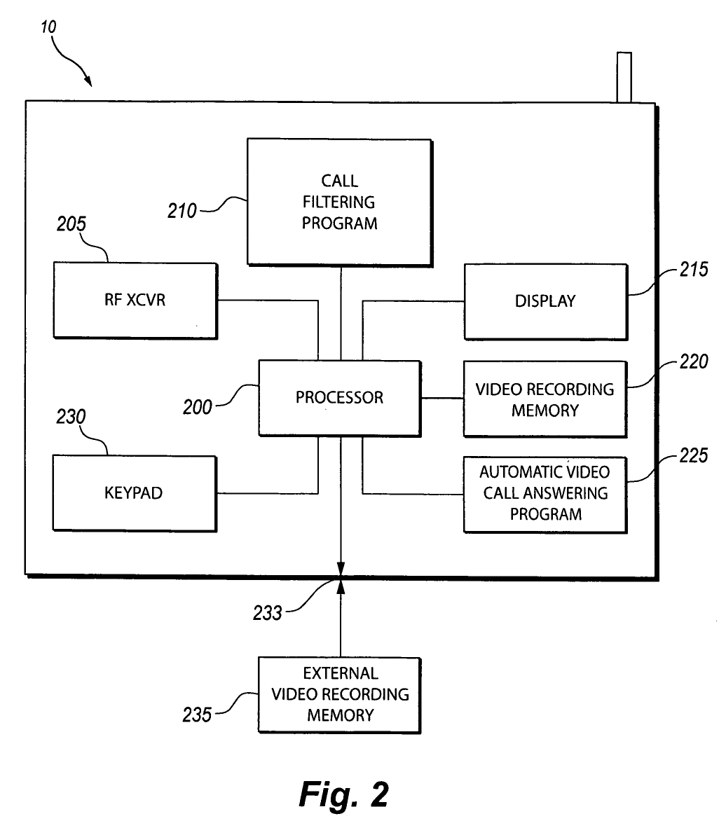

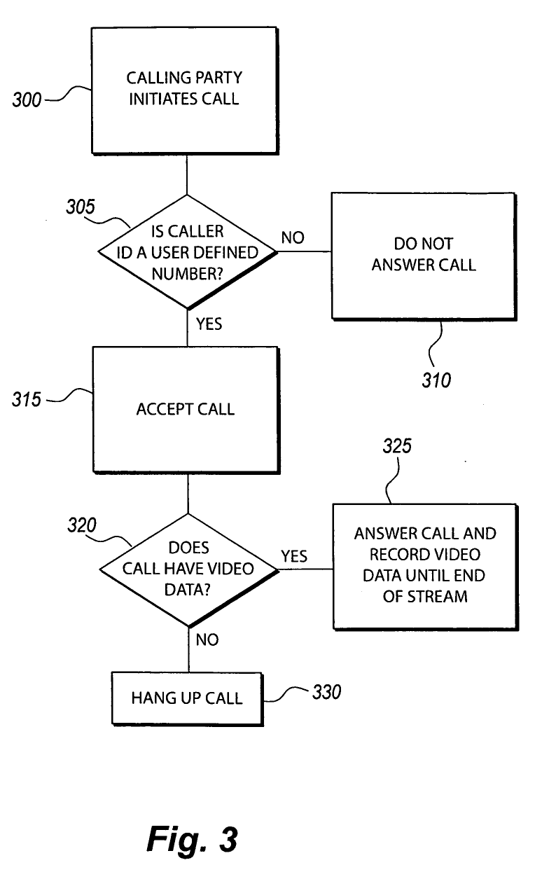

As shown in FIG. 3, the digital video recording logic, which may be implemented under coordination of processor 200, begins to process a call at step 300. At step 305, if the caller is defined, i.e., accepted by the call filtering program 210, then the call is answered at step 315, otherwise the call is rejected at step 310. At step 320 a determination is made whether the call has a video data stream to record. If there is no video data stream present, the 3G phone 10 hangs up the call at step 330. If a video data stream is present, the 3G phone 10 records the data stream until the end of the stream is encountered. As shown in FIG. 2, the device 10 may also have a data port 233 that can accept external video recording memory 235 for long playing video data streams. The external video recording memory 235 may be external RAM, FLASH, memory card, hard drive, another computer, or the like.

It is to be understood that the present invention is not limited to the embodiment described above, but encompasses any and all embodiments within the scope of the following claims.

I claim:

1. A remote video recorder for a mobile phone, comprising:
a third generation mobile phone;
a call filtering program operably connected to the third generation mobile phone, the call filtering program rejecting all incoming phone calls except for incoming phone calls from preselected telephone numbers specified by a user;
a memory storage device; and
an automatic video call answering program, the program automatically answering calls having video image and streaming video data and routing the data to the memory storage device for storage thereon;
whereby video taken on a caller's mobile phone is recordable on the memory storage device at a location remote from the caller's mobile phone when the caller's mobile phone has previously been specified as a preselected telephone number in the call filtering program by the user.

2. The remote video recorder according to claim 1, wherein the third generation mobile phone has a private telephone number.

3. The remote video recorder according to claim 1, wherein the third generation mobile phone has a keypad operably connected to the call filtering program for entering a user defined number for acceptance by the call filtering program.

4. The remote video recorder according to claim 1, wherein the call filtering program is programmed into the third generation mobile phone.

5. The remote video recorder according to claim 1, wherein the call filtering program is programmed into a discrete device operably connected to the third generation mobile phone.

6. The remote video recorder according to claim 1, wherein said memory storage device comprises a memory card insertable into the third generation mobile phone.

7. The remote video recorder according to claim 1, wherein said memory storage device comprises a hard disk drive of a computer operably connected to the third generation mobile phone.

8. A method of recording video images taken by a mobile phone onto a remote video recorder, comprising the steps of:
programming the mobile phone's telephone number into a call filtering program as a user authorized to record video data on the remote video recorder;
taking a video image with the mobile phone;
calling a telephone number of the remote video recorder from the mobile phone;
accepting the call when the call filtering program determines that the call is from the authorized user;
using a call answering program to detect video data on the call from the mobile phone and to route the video data to a memory storage device; and
recording the video data on the memory storage device.

9. The method of recording video images according to claim 8, wherein the video data includes an audio signal associated with the video data.
